(19) United States
(12) Patent Application Publication
(10) Pub. No.: US 2026/0118727 A1
(43) Pub. Date: Apr. 30, 2026

(54) DISPLAY DEVICE

(71) Applicant: Japan Display Inc., Tokyo (JP)

(72) Inventors: Koji KITAMURA, Tokyo (JP); Kentaro OKUYAMA, Tokyo (JP); Tenfu NAKAMURA, Tokyo (JP); Yoshihide OHUE, Tokyo (JP)

(73) Assignee: Japan Display Inc., Tokyo (JP)

(21) Appl. No.: 19/325,624

(22) Filed: Sep. 11, 2025

(30) Foreign Application Priority Data
Oct. 30, 2024 (JP) 2024-190435

(51) Int. Cl. G02F 1/1362; G02F 1/13357

(52) U.S. Cl. CPC G02F 1/136286; G02F 1/133615; G02F 1/133621

(57) ABSTRACT

A display device includes a plurality of gate lines, a plurality of image-signal lines intersecting the plurality of gate lines, and a plurality of pixels. The plurality of pixels is arranged in a matrix form having a plurality of rows and a plurality of columns and each electrically connected to a respective one of the plurality of gate lines and a respective one of the plurality of image-signal lines. Each of the plurality of gate lines has a zig-zag shape. A pitch of bending points of the zig-zag shape in a row direction is an integer multiple of a pitch of the plurality of image-signal lines in the row direction.

### CROSS-REFERENCE TO RELATED APPLICATIONS

This application claims the benefit of priority to Japanese Patent Application No. 2024-190435, filed on Oct. 30, 2024, the entire contents of which are incorporated herein by reference.

### FIELD

An embodiment of the present invention relates to a display device.

### BACKGROUND

In recent years, display devices including a liquid crystal layer composed of a polymer-dispersed liquid crystal in each pixel have been proposed. In such a liquid crystal layer, the transmission and scattering of light incident on the liquid crystal layer can be controlled by the voltage applied to the liquid crystal layer. The application of this feature enables the production of pixels capable of transmitting light and pixels capable of scattering light by controlling the voltage applied to the liquid crystal layer. Therefore, in the display devices containing a polymer-dispersive liquid crystal, images can be displayed using the light-scattering pixels, while providing a light-transmitting property to the display devices using the light-transmitting pixels. Accordingly, so-called transparent display devices can be provided. For example, a structure is proposed in Japanese Laid-Open Patent Publication No. 2019-66640 in which scattering of light from a light source caused by gate lines is prevented to selectively cause light scattering in the liquid crystal layer so that degradation of image quality is prevented.

### SUMMARY

An embodiment of the present invention is a display device. The display device includes a plurality of gate lines, a plurality of image-signal lines intersecting the plurality of gate lines, and a plurality of pixels. The plurality of pixels is arranged in a matrix form having a plurality of rows and a plurality of columns and each electrically connected to a respective one of the plurality of gate lines and a respective one of the plurality of image-signal lines. Each of the plurality of gate lines has a zig-zag shape. A pitch of bending points of the zig-zag shape in a row direction is an integer multiple of a pitch of the plurality of image-signal lines in the row direction.

### BRIEF DESCRIPTION OF DRAWINGS

FIG. 1 is a schematic enlarged perspective view of a display device according to an embodiment of the present invention.

FIG. 2 is a schematic cross-sectional view of a display device according to an embodiment of the present invention.

FIG. 3 is an equivalent circuit diagram of a pixel of a display device according to an embodiment of the present invention.

FIG. 4 is a schematic top view of a display device according to an embodiment of the present invention.

FIG. 5 is a schematic top view of a display device according to an embodiment of the present invention.

FIG. 6 is a schematic top view of a display device according to an embodiment of the present invention.

FIG. 7 is a schematic top view of a display device according to an embodiment of the present invention.

FIG. 8 is a schematic top view of a display device according to an embodiment of the present invention.

FIG. 9 is a schematic cross-sectional view of a display device according to an embodiment of the present invention.

FIG. 10 is a schematic cross-sectional view of a display device according to an embodiment of the present invention.

FIG. 11 is a schematic top view of a display device according to an embodiment of the present invention.

FIG. 12 is a schematic top view of a display device according to an embodiment of the present invention.

FIG. 13 is a schematic top view of a display device fabricated in the Example.

FIG. 14 is a schematic top view of a display device fabricated in the Example.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate.

In the present invention, when a certain single film is processed to form a plurality of films, the plurality of films may include different functions and roles. However, the plurality of films are derived from a film formed in the same process and the same layer, and essentially include the same layer structure, the same materials and the same morphology. Therefore, the plurality of films are defined as existing in the same layer.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

In the specification and claims, an expression that a structure is exposed from another structure means a mode where the portion of the structure is not covered by the other structure and includes a mode where the portion uncovered by the other structure is further covered by another structure. In addition, a mode expressed by this expression includes a mode where the structure is not in contact with the other structures.

### 1. Outline Structure of Display Device

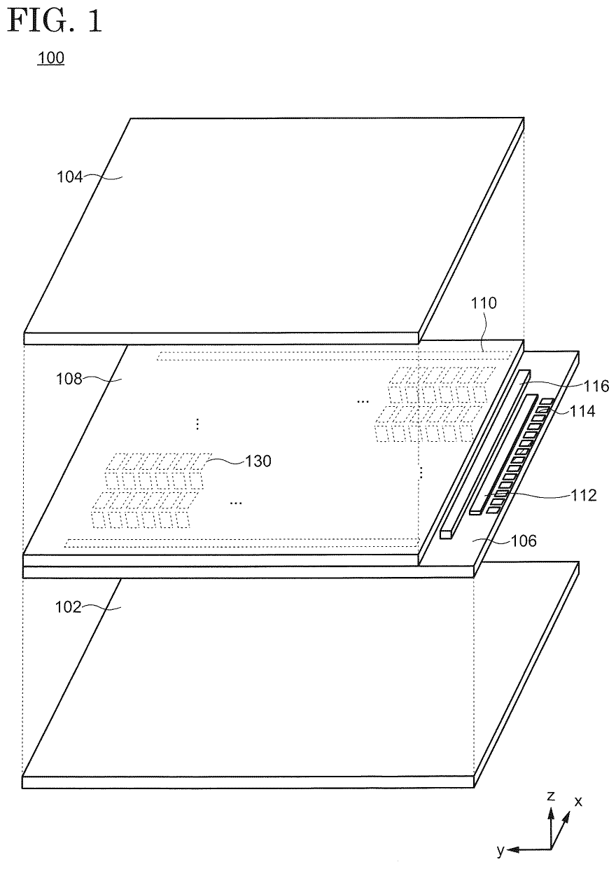

FIG. 1 shows a schematic development view of a display device 100 according to an embodiment of the present invention. The display device 100 is a liquid crystal display device having a polymer-dispersed liquid crystal and has an array substrate 106 and a counter substrate 108 facing the array substrate 106. A variety of patterned conductive films, insulating films, and semiconductor films is provided over the array substrate 106, and appropriate combination of these films results in a plurality of pixels 130, driver circuits (gate-line driver circuit 110 and signal-line driver circuit 112) to control the pixels 130, terminals 114, and the like. A light source 116 is further provided over the array substrate 106. The display device 100 is further provided with a pair of light-guide plates 102 and 104 sandwiching the array substrate 106 and the counter substrate 108. A region surrounding all of the pixels 130 and a region between adjacent pixels 130 over the array substrate 106 is called a display region, while a region surrounding the display region is called a frame region. Hereinafter, these components are described in detail.

### (1) Array Substrate, Counter Substrate, and Light-Guide Plate

Both the array substrate 106 and the counter substrate 108 are provided to provide physical strength to the display device 100 and to provide a surface for supporting a variety of components (e.g., the pixels 130 and the driver circuits) to express the functions as a display device. Both the array substrate 106 and the counter substrate 108 are configured to transmit at least a portion of visible light. Therefore, the array substrate 106 and the counter substrate 108 may be a glass substrate, a quartz substrate, or a polymer substrate of a polyimide, a polyamide, a polycarbonate, and the like. The array substrate 106 and/or the counter substrate 108 may be flexible. For example, the array substrate 106 and/or the counter substrate 108 may be flexible to the extent so as to be elastically deformable or plastically deformable. The array substrate 106 and the counter substrate 108 are secured to each other using a sealing material which is not depicted in FIG. 1. As can be understood from FIG. 1, a portion of the array substrate 106 is exposed from the counter substrate 108, and a portion or the entire driver circuit, terminals 114, the light source 116, and the like are arranged in this exposed portion.

Similar to the array substrate 106 and the counter substrate 108, the light-guide plates 102 and 104 are also provided to provide physical strength to the display device 100 and to efficiently supply light from the light source 116 to the pixels 130 as described below. The light-guide plates 102 and 104 are also configured to transmit visible light and are configured, for example, to include glass, quartz, or the polymer described above. The light-guide plates 102 and 104 are respectively fixed to the array substrate 106 and the counter substrate 108 with an adhesive or the like which is not illustrated.

### (2) Driver Circuit and Terminal

The driver circuits are the components for controlling the plurality of pixels 130. As shown in FIG. 1, a part or the entire driver circuit (e.g., the gate-line driver circuit 110) may be composed of conductive films, semiconductor films, and insulating films patterned over the array substrate 106. In this case, the driver circuit is arranged and protected between the array substrate 106 and the counter substrate 108. Alternatively, a part or the entire driver circuit (e.g., a part or the entire signal-line driver circuit 112) may be formed by mounting an integrated circuit formed over a semiconductor substrate over the array substrate 106. In this case, the driver circuit is arranged over the array substrate 106 or over a connector described below so as to be exposed from the counter substrate 108.

The terminals 114 are formed by one or a plurality of conductive films patterned over the array substrate 106 and are exposed from the counter substrate 108. The terminals 114 are electrically connected to the driver circuits and also to an external circuit (not illustrated) via the connector such as a flexible printed circuit (FPC) board which is not illustrated in FIG. 1. As a result, power and a variety of signals supplied from the external circuit are supplied to the driver circuits via the terminals 114. The driver circuits generate a variety of control signals (e.g., gate signals, image signals, reset signals, and the like) to control the pixel 130 on the basis of the supplied signals and supply the control signals to the pixels 130 via gate lines and image-signal lines which are not illustrated in FIG. 1. Accordingly, images can be created on the display region.

### (3) Pixel

The pixel 130 functions as the smallest unit providing color information and is provided over the array substrate 106. The pixels 130 are arranged in a matrix form having a plurality of rows and a plurality of columns. Hereinafter, the row direction is defined as an x-direction, while the column direction is defined as a y-direction as shown in FIG. 1. The normal direction of the array substrate 106 is a z-direction. When the array substrate 106 and/or the counter substrate 108 are rectangular, the x-direction and y-direction may be set to be respectively parallel to two interconnected sides of the array substrate 106 and/or the counter substrate 108. Details regarding the configuration of the pixel 130 will be described later.

### (4) Light Source

The light source 116 is provided over the array substrate 106 and is exposed from the counter substrate 108. In other words, the light source 116 is arranged so as not to overlap the display region in the z-direction. The light source 116 has light-emitting elements providing three primary colors. More specifically, a plurality of red-emissive light-emitting elements, a plurality of green-emissive light-emitting elements, and a plurality of blue-emissive light-emitting elements are provided in the light source 116. Each light-emitting element is composed of an organic or inorganic electroluminescent element, preferably an inorganic electroluminescent element, where inorganic electroluminescent elements capable of emitting light with high brightness and having a long device lifetime are preferably used. Although not illustrated, the plurality of light-emitting elements is arranged in the row direction. In addition, the light source 116 is configured so that the light emitted from the light-emitting elements is mainly emitted in the y-direction (i.e., in the row direction).

The driving mode of the display device 100 may be arbitrarily set. For example, the display device 100 may be driven in the field sequential mode. In this case, the light source 116 is configured so that the light-emitting elements of different emission colors do not turn on simultaneously, and the plurality of red-emissive light-emitting elements, the plurality of green-emissive light-emitting elements, and the plurality of blue-emissive light-emitting elements turn on sequentially for each frame period. This mode allows all of the pixels 130 to function as the units providing red, green, and blue information, enabling full-color display even in the absence of color filters.

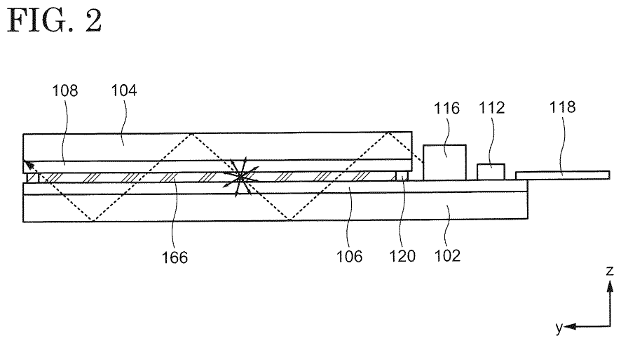

FIG. 2 shows a schematic cross-sectional view of the display device 100. As described in detail below, a liquid crystal layer 166 containing a polymer-dispersed liquid crystal is arranged in the space formed by the array substrate 106, the counter substrate 108, and the sealing material 120 fixing the array substrate 106 and the counter substrate 108. Power and signals to drive the light source 116 are input to the light source 116 from the connector 118 through the terminal 114, and the light-emitting elements in the light source 116 emit light in the y-direction on the basis of the power and the signals. The emitted light enters the light-guide plate 104, and a part of the light travels in the y-direction while repeating total reflection between the top surface of the light-guide plate 104 and the bottom surface of the light-guide plate 102 (see the dotted arrow in FIG. 2). At this time, the light scattering property of the liquid crystal layer 166 is controlled by controlling the voltage applied to the liquid crystal layer 166 in each pixel 130. When the voltage applied to the liquid crystal layer 166 is controlled so that the liquid crystal layer 166 does not scatter the light but transmits the light, the light is transmitted without scattering in that pixel 130, and total reflection of the light is repeated. Therefore, the light at that pixel is not visible from the outside. However, because that pixel 130 transmits the light, the background behind the display device 100 can be viewed. On the other hand, when the voltage applied to the liquid crystal layer 166 is controlled so that the liquid crystal layer 166 scatters the light, the light is scattered in that pixel 130 (see solid arrow in FIG. 2), and a part of the light is emitted outside through the array substrate 106 and the light-guide plate 102 or the counter substrate 108 and the light-guide plate 104. Therefore, color information can be obtained from that pixel 130. Using this principle, a variety of images can be created on the display region by appropriately combining the pixels 130 in which the liquid crystal layer 166 scatters the light. Note that the liquid crystal layer 166 may be configured to scatter the light from the light source 116 or may be configured to transmit light when a voltage is applied to the liquid crystal layer 166.

### 2. Structure of Pixel

### (1) Fundamental Structure of Pixel

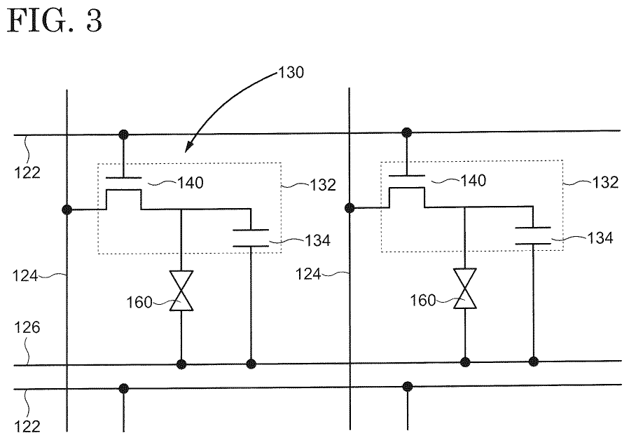

An equivalent circuit diagram of the pixel 130 is shown in FIG. 3. Here, the equivalent circuit diagram of two pixels 130 is demonstrated. The plurality of gate lines 122 extends from the gate-line driver circuit 110 to the display region over the array substrate 106. Meanwhile, the plurality of image-signal lines 124 extends from the plurality of signal-line driver circuits 112 to the display region. The plurality of gate lines 122 and the plurality of signal-line driver circuits 112 intersect each other. The region surrounded by two adjacent gate lines 122 and two adjacent image-signal lines 124 corresponds to one pixel 130. In each pixel 130, a pixel circuit 132 electrically connected to the liquid crystal element 160 is provided along with the liquid crystal element 160. Each pixel circuit 132 is electrically connected to a respective one of the plurality of gate lines 122 and a respective one of the plurality of signal-line driver circuits 112.

The structure of the pixel circuit 132 may be arbitrarily determined, and the pixel circuit may include at least one transistor 140 and at least one storage capacitor element 134. In this case, a gate electrode of the transistor 140 is electrically connected to the gate line 122, and one terminal is connected to the image-signal line 124. The other terminal of the transistor 140 is electrically connected to the liquid crystal element 160 (more particularly, a pixel electrode of the liquid crystal element 160 described below) and one electrode (capacitor electrode) of the storage capacitor element 134. The other electrode of the liquid crystal element 160 (more specifically, a common electrode of the liquid crystal element 160 described later) and the storge capacitor element 134 are electrically connected to a common wiring 126 to which a constant potential is supplied. As described above, there are no restrictions on the structure of the pixel circuit 132. Therefore, the pixel circuit 132 may be configured using a plurality of transistors and a plurality of storage capacitor elements although not illustrated in FIG. 3.

### (2) Shape of Gate Line

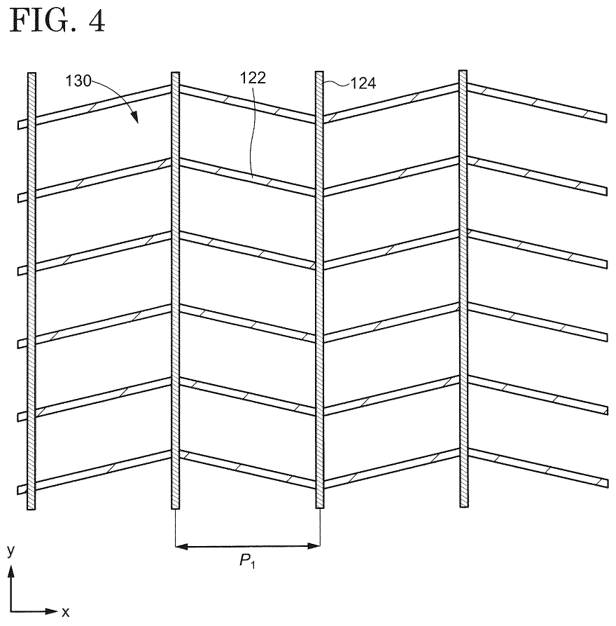

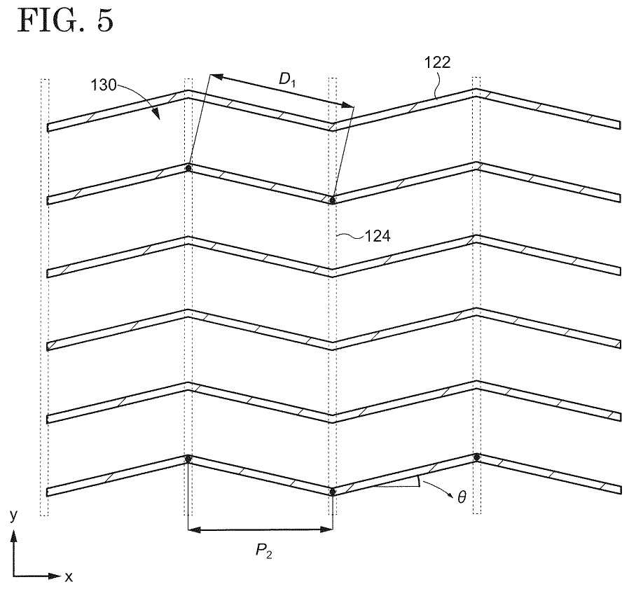

Schematic top views of a portion of the display device 100 are shown in FIG. 4 and FIG. 5. In these drawings, a total of 20 pixels 130 arranged in 5 rows and 4 columns as well as the gate lines 122 and the image-signal lines 124 connected to these pixels 130 are depicted. However, the image-signal lines 124 are shown using dotted lines in FIG. 5. Moreover, each component structuring the transistor 140 is not illustrated in these drawings for visibility.

As shown in these drawings, each gate line 122 is configured to have a zig-zag shape in a plane view. In other words, each gate line 122 is configured so that, although the extending direction is in the x-direction as a whole (i.e., the row direction), most of the gate line 122 is inclined from the x-direction, and the extending direction is switched at a certain period. In each gate line 122, the angle θ between the x-direction and an extending direction of a virtual straight line terminating at adjacent bending points of the zig-zag structure (black circles in FIG. 5) is greater than 0° and less than 90°. As described below, the zig-zag structure prevents a decrease in display contrast and improves display quality. However, since the gate line 122 becomes longer, the load on the gate line 122 increases. Furthermore, when θ increases, the zig-zag shape may be reflected in the image contours, depending on the size of pixel 130. Therefore, θ may be set in consideration of the balance of these characteristics and is preferably equal to or greater than 15° and equal to or less than 45°. Due to such a shape of the gate line 122, the shape of each pixel 130 can be regarded as an approximate parallelogram. Note that the bending point of the zig-zag structure is the point where the directions of two adjacent linear portions, which are inclined from the x-direction and have different extending directions, intersect each other. Each linear portion has a length longer than a pitch P₁ (see FIG. 4) of the image-signal lines in the x-direction and has a constant width.

As shown in FIG. 5, the gate lines 122 are configured so that the bending point of the zig-zag structure is located between adjacent pixels 130 (i.e., diagonally opposite pixels 130) in the direction inclined from the x-direction or the y-direction through the image-signal line 124. Thus, each bending point of the zig-zag structure may overlap any of the plurality of image-signal lines 124. In contrast, the image-signal lines 124 extend approximately along the y-direction. Therefore, the distance Di (i.e., the length of the virtual straight line) between adjacent bending points is longer than the pitch P₁ of the image-signal lines 124 in the row direction. On the other hand, the pitch P₂ of the bending points in the x-direction is the same as the pitch P₁ of the image-signal line 124. This configuration allows the bending points of the zig-zag structure to be arranged so as to overlap the image-signal lines 124 without being present between adjacent image-signal lines 124.

### (3) Arrangement of Pixel Circuit and Liquid Crystal Element

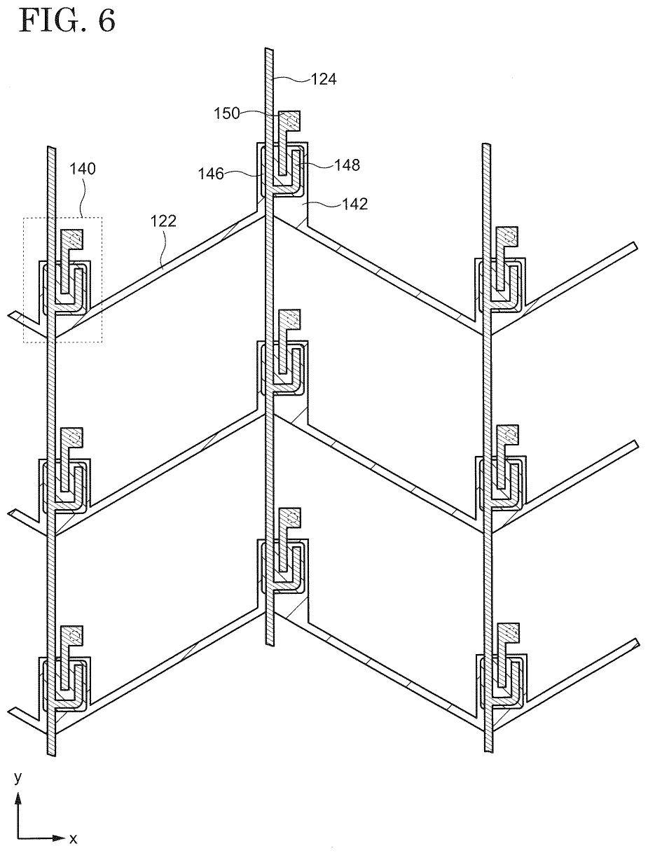

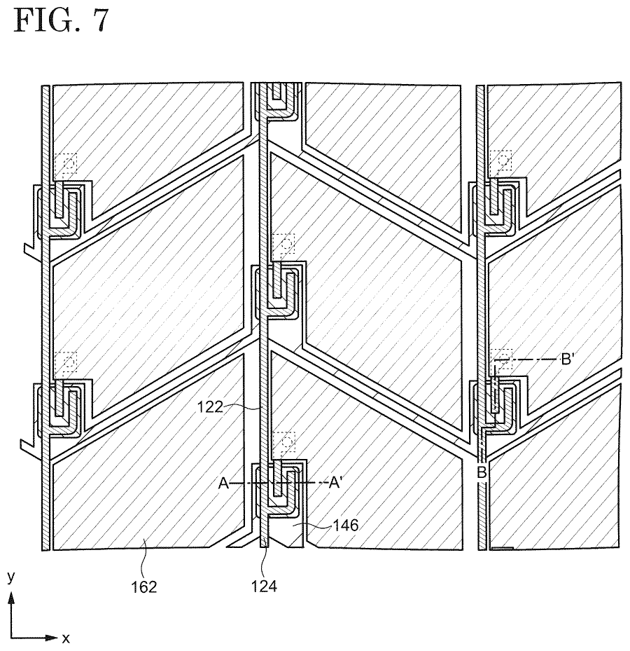

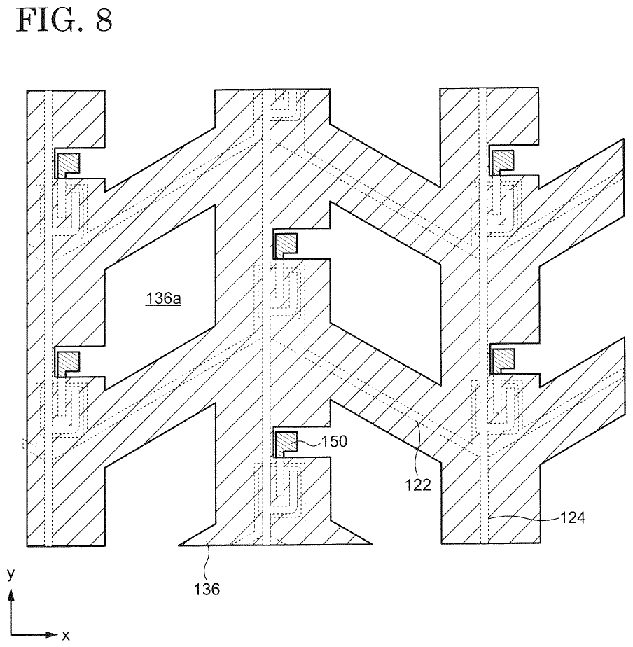

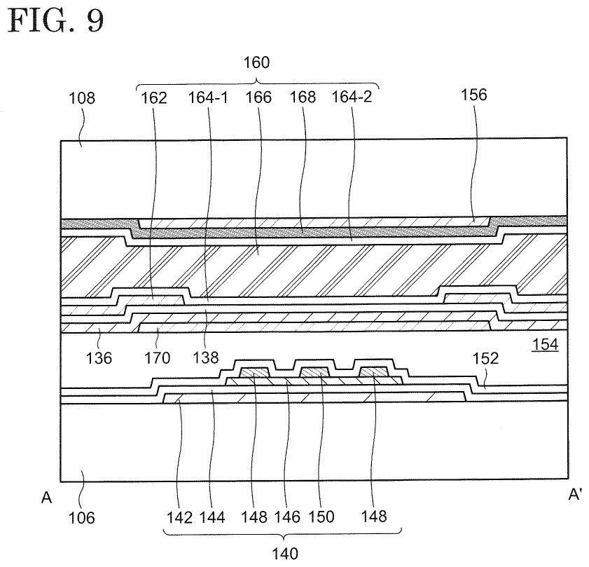

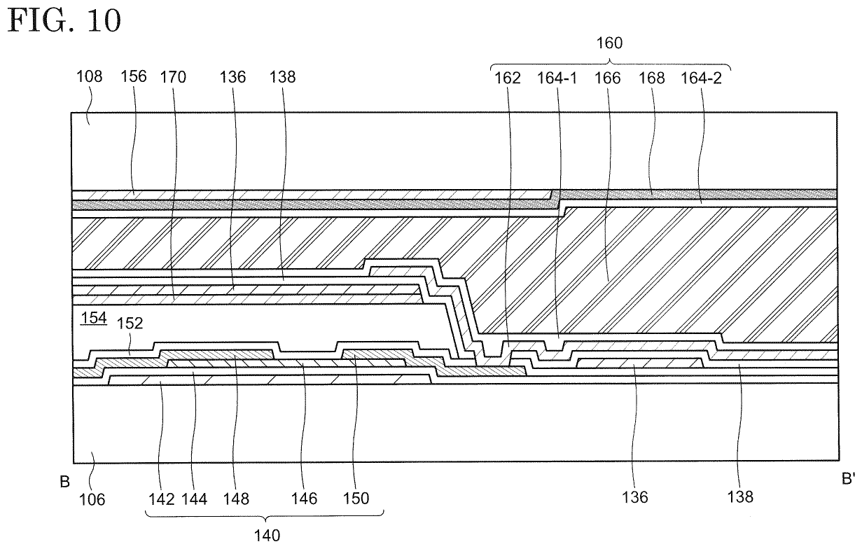

Schematic top views of the display device 100 are shown in FIG. 6 to FIG. 8, and schematic views of the cross sections along the chain lines A-A′ and B-B′ in FIG. 7 are respectively shown in FIG. 9 and FIG. 10. The capacitor electrode of the storage capacitor element 134 and the pixel electrode structuring the liquid crystal element 160 are not depicted in FIG. 6 for visibility, and the main components including the gate lines 122, the image-signal lines 124, and the transistors 140 are shown. FIG. 7 is a schematic view of FIG. 6 to which the pixel electrode 162 is added, and FIG. 8 is a schematic view of FIG. 6 to which the capacitor electrodes 136 of the storage capacitor element 134 is added.

As shown in FIG. 6, the bending point and its vicinity of the gate line 122 having the zig-zag structure extends in the y-direction and serves as a gate electrode 142 of the transistor 140. As shown in FIG. 9 and FIG. 10, a gate insulating film 144 is disposed over the gate electrode 142 to cover the gate electrode 142, and a semiconductor film 146 overlapping the gate electrode 142 is stacked over the gate insulating film 144. Meanwhile, as can be understood from FIG. 6 and FIG. 7, a portion of the image-signal line 124 overlaps the gate electrode 142 and the semiconductor film 146 and is in contact with the semiconductor film 146 (FIG. 9 and FIG. 10). This portion functions as a source electrode 148 of the transistor 140. Furthermore, a drain electrode 150 overlapping the gate electrode 142 and the semiconductor film 146 and existing in the same layer as the image-signal line 124 is provided so as to be in contact with the semiconductor film 146. The gate electrode 142, the gate insulating film 144, the semiconductor film 146, the source electrode 148, and the drain electrode 150 constitute the transistor 140. The transistor 140 of the pixel circuit 132 is turned on by supplying a gate signal to the gate line 122, and input of a potential to the image signal via the transistor 140 in this state allows a potential corresponding to the image signal to be supplied to the liquid crystal element 160.

An interlayer insulating film 152, which also functions as a protective film, is disposed over the transistor 140 as an optional component, over which a leveling film 154 is provided to absorb the unevenness caused by the pixel circuit 132 and provide a flat surface (FIG. 9 and FIG. 10). The leveling film 154 is removed by etching in the region where the liquid crystal device 160 is to be provided, and the interlayer insulating film 152 is exposed from the leveling film 154 in this region (FIG. 10). As shown in FIG. 9, an auxiliary wiring 170 for supplying a potential to the storage capacitor element 134 is provided over the leveling film 154 so as to overlap the image-signal line 124 and a part thereof serving as the source electrode 148.

The capacitor electrode 136 of the storage capacitor element 134 is provided over the auxiliary wiring 170 so as to be in contact with the auxiliary wiring 170. Here, the capacitor electrode 136 is provided so as to overlap the pixel electrode 162 of the liquid crystal element 160 and expose a contact hole (see the dotted circle in FIG. 6 and FIG. 8 and FIG. 10) for the contact between the drain electrode 150 and the pixel electrode 162. Moreover, the capacitor electrode 136 is provided across adjacent pixels 130 so as to be shared by all of the pixels 130 (see FIG. 8). Although not illustrated, the auxiliary wiring 170 is connected to the common wiring 126 in the frame region, by which a constant potential is supplied thereto. As described below, since the auxiliary wiring 170 is configured to include a metal such as aluminum, the voltage drop of the capacitor electrode 136 can be prevented by arranging the capacitor electrode 136 so as to be in contact with the auxiliary wiring 170 even if the capacitor electrode 136 having a relatively large area is provided so as to be shared by all of the pixels 130.

A capacitance insulating film 138 is provided over the capacitor electrode 136 of the storge capacitor element 134 and the interlayer insulating film 152, and the pixel electrode 162 of the liquid crystal element 160 is formed over the capacitance insulating film 138. A contact hole is formed in the interlayer insulating film 152 and the capacitance insulating film 138 to expose the drain electrode 150, and the electrical connection is performed between the pixel electrode 162 and the drain electrode 150 through this contact hole, by which the pixel circuit 132 and the liquid crystal element 160 are electrically connected. Unlike the capacitor electrode 136, the pixel electrode 162 is formed for each pixel 130. Therefore, the potential of the pixel electrode 162 is controlled in each pixel 130. The pixel electrode 162 overlaps the capacitor electrode 136 via the capacitance insulating film 138, and the storage capacitor element 134 is structured by the capacitor electrode 136, the pixel electrode 162, and the capacitance insulating film 138 sandwiched therebetween. In other words, the pixel electrode 162 is shared by the liquid crystal element 160 and the storage capacitor element 134. As shown in FIG. 8, the capacitor electrode 136 may be provided with an opening 136a overlapping the pixel electrode 162. The capacity of the storage capacitor element 134 can be adjusted by adjusting the size of the opening 136a as appropriate.

A first orientation film 164-1 is provided over the pixel electrode 162. On the other hand, a light-shielding film 156 overlapping the pixel circuit 132, the image-signal line 124, and the gate line 122 is provided over the counter substrate 108 (under the counter substrate 108 in FIG. 9 and FIG. 10. Hereinafter, the same is applied.). Furthermore, a counter electrode 168 is provided so as to cover the light-shielding film 156, and a second orientation film 164-2 is arranged to cover the counter electrode 168. The liquid crystal layer 166 including a polymer-dispersed liquid crystal is provided between the first orientation film 164-1 and the second orientation film 164-2. The liquid crystal element 160 is structured by the pixel electrode 162, the first orientation film 164-1, the liquid crystal layer 166, the second orientation film 164-2, and the counter electrode 168.

The above-described components can be formed using known materials. In brief, the gate line 122, the image-signal line 124, and the auxiliary wiring 170 are configured to include a metal such as molybdenum, tungsten, titanium, tantalum, aluminum, and copper or an alloy including a metal selected from these metals. These components may have a single-layer structure or a stacked-layer structure. Preferably, the image-signal line 124 and the auxiliary wiring 170 are configured to include aluminum to reduce electrical resistance, and a stacked structure of titanium/aluminum/titanium is employed, for example.

The semiconductor film 146 may be composed of a Group 14 element exemplified by silicon or an oxide semiconductor containing indium. There is no restriction on the crystallinity of the semiconductor film 146, and the semiconductor film 146 may be amorphous or polycrystalline. It is preferable to use a polycrystalline semiconductor film 146 to obtain a higher carrier mobility. For example, when the semiconductor film 146 includes or consists of an oxide semiconductor, the semiconductor film 146 is preferred to include indium and a metal element other than indium. A metal element other than indium includes gallium, zinc, aluminum, hafnium, yttrium, zirconium, and lanthanide metals. The semiconductor film 146 containing or consisting of an oxide semiconductor may be formed by a sputtering method or an atomic layer deposition (ALD) method.

The gate insulating film 144, the interlayer insulating film 152, and the capacitance insulating film 138 may be composed of one or a plurality of layers containing a silicon-containing inorganic compound such as silicon oxide and silicon nitride. These films may be formed by a sputtering method, a chemical vapor deposition (CVD) method, or the like. The leveling film 154 includes a polymer such as a polyimide, a polyamide, an acrylic resin, and an epoxy resin and is formed using a spin-coating method, a dip-coating method, a printing method, an inkjet method, or the like, for example. Similarly, the first orientation film 164-1 and the second orientation film 164-2 are also composed of a polymer such as a polyimide, and their surfaces are subjected to a rubbing treatment.

The capacitor electrode 136, the pixel electrode 162, and the counter electrode 168 are configured to transmit visible light. Accordingly, these electrodes include a light-transmitting oxide such as indium-tin oxide (ITO) and indium-zinc oxide (IZO) and are formed using a sputtering method or the like. The light-shielding film 156 may be formed using a metal with low reflectance to visible light, such as chromium, or a resin containing a black or similarly colored pigment.

The liquid crystal layer 166 may be formed by injecting liquid crystal molecules and a monomer containing a liquid crystal unit into the space formed by the array substrate 106, the counter substrate 108, and the sealing material 120 (see FIG. 2) and polymerizing the monomer. As a result, the polymer-dispersed liquid crystal having a structure in which a polymer network resulting from the monomer and the liquid crystal molecules are phase-separated can be obtained as the liquid crystal layer 166.

As described above, since display is performed using the light scattering caused by the liquid crystal element 160 of the pixel 130 in the transparent display devices, the display quality is degraded wen the light is scattered by a component other than the liquid crystal element 160. In particular, unlike the image-signal line 124 extending almost parallel to the direction of the light emission from the light source 116, the gate line 122 intersects the image-signal line 124. Hence, when the light perpendicularly enters the edge surface of the gate line 122, the light readily reflects diffusely. When such diffuse reflection of the light occurs, the scattered light is visible through the pixel 130 even in a black display state, for example, resulting in a reduction in image contrast.

However, since the gate lines 122 have the zig-zag structure in the display device 100, the edge faces of the gate lines 122 are oblique to the travelling direction of the light. Furthermore, the gate line 122 may be provided so that the bending point overlaps the image-signal line 124. Therefore, as demonstrated in the Example, scattering of the light emitted from the light source 116 on the surface of the gate line 122 can be significantly suppressed, and as a result, contrast reduction is prevented and display quality is improved. Therefore, the implementation of an embodiment of the present invention enables the production of a display device and a transparent display device capable of high-quality display.

### 3. Modified Example

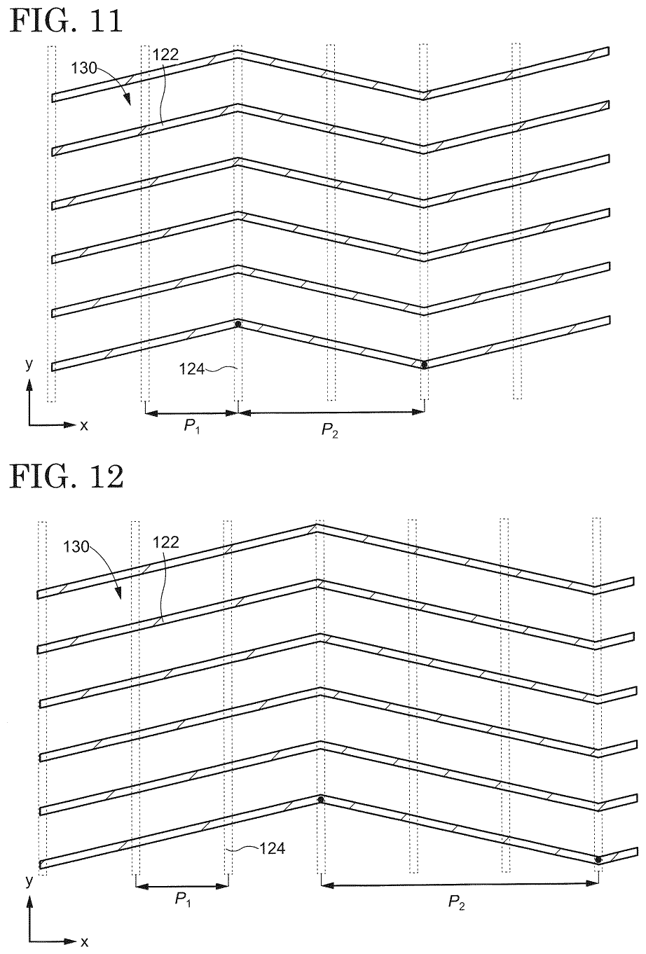

In the above example, the pitch P₂ of the bending points of the zig-zag structure of the gate line 122 in the x-direction is the same as the pitch P₁ of the image-signal line 124. However. the pitch P₂ may be different from the pitch P₁ and may be an integer multiple (n times) of the pitch P₁, for example. Here, n is an integer. Specifically, the pitch P₂ may be twice or three times as large as the pitch P₁ as shown in FIG. 11 and FIG. 12. There are no restrictions on the maximum value of n, and n is preferred to be an integer equal to or greater than 1 and equal to or less than 4, for example. In such a configuration, the bending points of the zig-zag structure can be arranged so that they do not exist between adjacent image-signal lines 124 but overlap the image-signal lines 124.

### EXAMPLES

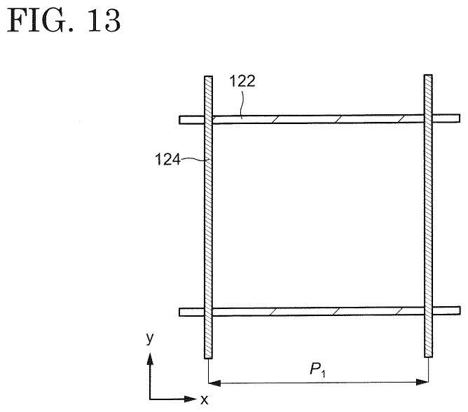

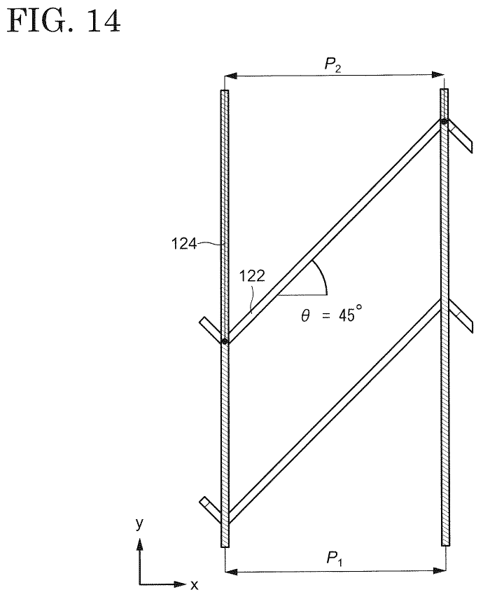

In the Example, the results of fabricating display devices with different shapes of the gate line 122 and evaluating the influences of the scattering of the light from the light source 116 on the gate line 122 are described. Specifically, display devices with gate lines 122 having the structures shown in FIG. 13 and FIG. 14 were fabricated. In the structure shown in FIG. 13 (Comparative Example), the gate line 122 has no bending points and linearly extends in the x-direction. On the other hand, the structure demonstrated in FIG. 14 (Example) is the structure of the gate line 122 in the display device 100 according to an embodiment of the present invention, where the pitch P₂ of the bending points in the x-direction is the same as the pitch P₁ of the image-signal line 124, and the bending points overlap the image-signal lines 124. The angle in the x-direction between the virtual straight line terminating at the adjacent bending points and the x-direction is 45°.

Black display was performed in all of the pixels of the display devices of the Example and the Comparative Example, the luminance at 10 measurement points was measured in each display device, and the average luminance was obtained. As a result, the relative luminance of the display device of the Example was 0.80 when the luminance of the display device of the Comparative Example (FIG. 13) was set to be 1. The above results indicate that the implementation of an embodiment of the present invention suppresses light leakage caused by the light scattering on the gate line 122, enabling display with higher contrast.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of the radio-wave reflection element or the intelligent reflecting surface is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. A display device comprising:
a plurality of gate lines;
a plurality of image-signal lines intersecting the plurality of gate lines; and
a plurality of pixels arranged in a matrix form having a plurality of rows and a plurality of columns and each electrically connected to a respective one of the plurality of gate lines and a respective one of the plurality of image-signal lines,
wherein each of the plurality of gate lines has a zig-zag shape, and
a pitch of bending points of the zig-zag shape in a row direction is an integer multiple of a pitch of the plurality of image-signal lines in the row direction.

2. The display device according to claim 1,
wherein the pitch of the bending points of the zig-zag shape in the row direction is n times the pitch of the plurality of image-signal lines in the row direction, and
n is selected from integers equal to or greater than 1 and equal to or less than 4.

3. The display device according to claim 1,
wherein a distance between adjacent bending points is longer than the pitch of the plurality of image-signal lines in the row direction.

4. The display device according to claim 1,
wherein the bending points each overlap any of the plurality of image-signal lines.

5. The display device according to claim 1,
wherein the bending point is located between adjacent pixels in a direction inclined from the row direction through the image-signal line.

6. The display device according to claim 1,
wherein each of the plurality of gate lines is configured so that a length of a virtual straight line terminating at adjacent bending points is longer than the pitch of the plurality of image-signal lines in the row direction.

7. The display device according to claim 6,
wherein an angle between the virtual straight line and the row direction is equal to or greater than 15° and equal to or less than 45°.

8. The display device according to claim 1,
wherein each of the plurality of pixels comprises a liquid crystal element.

9. The display device according to claim 8,
wherein the liquid crystal element includes a polymer-dispersed liquid crystal.

10. The display device according to claim 1, further comprising:
an array substrate under the plurality of gate lines, the plurality of image-signal lines, and the plurality of pixels; and
a light source located under the array substrate and comprising a plurality of light-emitting elements,
wherein the plurality of light-emitting elements is arranged parallel to the row direction.

11. The display device according to claim 10.
wherein the light source is configured to sequentially emit light of three primary colors.
